(19) United States
(12) Patent Application Publication
(10) Pub. No.: US 2010/0107527 A1
(43) Pub. Date: May 6, 2010

(54) Frame Device for Use in Building-in a Balcony

(75) Inventor: Lars Björkman, Kalmar (SE)

Correspondence Address: BUCHANAN, INGERSOLL & ROONEY PC, POST OFFICE BOX 1404, ALEXANDRIA, VA, 22313-1404, US

(73) Assignee: NORDISKA BALCO AB, Vaxjo (SE)

(21) Appl. No.: 11/992,320

(22) PCT Filed: Oct. 18, 2006
(86) PCT No.: PCT/SE2006/001176

§ 371 Date: Apr. 22, 2008

(30) Foreign Application Priority Data
Nov. 10, 2005 (SE) 0502478-1

(51) Int. Cl. E06B 3/96; E04B 1/38

(52) U.S. Cl. 52/211; 52/710

(57) ABSTRACT

A frame device adapted to be mounted between a balcony slab and a roof slab (2) located above the former supports wall elements (16, 16′, 16″) for building-in a balcony. The frame device has an upper horizontal sectional element (17), which supports a cover strip (28), which extends parallel thereto and is fastened thereto by holder means (26). The cover strip (28) has a leg (28a), which is inserted into a pocket (27) formed between the holder means (26) and a supporting surface (25) of the sectional element (17). The cover strip (28) is extractable from a retracted position in the pocket (27) to an arbitrarily extracted position so as to provide, when the frame device is mounted between the balcony slab and the roof slab (2), a visual screening off of a gap (S), which is formed between the roof slab (2) and the sectional element (17).

### FIELD OF THE INVENTION

The present invention relates to a frame device, which is adapted to be mounted between a balcony slab and a roof slab located straight above the former and to support wall elements, such as glass plates, for at least partial building-in of a balcony and which has an upper horizontal sectional element, which is adapted to be positioned, when mounting the frame device, close to the roof slab.

### BACKGROUND ART

Prior art frame devices of this kind, besides having an upper horizontal sectional element, also have a lower horizontal sectional element and at each side a vertical sectional element. When building-in a balcony, which has a balcony slab and a roof slab located straight above the former, the lower horizontal sectional element of such a frame device is placed on supporting elements, which are fastened to one of the edge surfaces of the balcony slab and project slightly from this edge surface. The upper horizontal sectional element of the frame device is subsequently fastened to supporting elements, which are fastened to the corresponding edge surface of the roof slab and project slightly therefrom, the upper horizontal sectional element being positioned close to the roof slab. However, between the roof slab and the upper horizontal sectional element, a gap forms, through which are visible, from the balcony, parts of the supporting elements that are fastened to the edge surface of the roof slab as well as bolted joints, if any, for attachment of the frame device. For aesthetic reasons, this gap is presently hidden by covering plates which, after the mounting of the frame device, are positioned and screwed to the underside of the roof slab and/or to the inside of the upper horizontal sectional element. This means that relatively time-consuming extra work is needed after the mounting of the frame device.

### SUMMARY OF THE INVENTION

The object of the present invention is to provide a frame device, which is so constructed that this extra work is reduced to a minimum.

This object is achieved by a frame device, which is of the type stated by way of introduction and characterised in that the sectional element supports a cover strip, which is fastened thereto by holder means and which extends parallel to the sectional element and has a leg, which is inserted into a pocket formed between the holder means and a supporting surface of the sectional element, the cover strip being extractable from a retracted position in the pocket to an arbitrarily extracted position so as to provide, when the frame device is mounted between the balcony slab and the roof slab, a visual screening off of a gap, which is formed between the roof slab and the sectional element.

By means of a frame device thus constructed, a visual screening off of the gap formed after the mounting of the frame device is obtained simply by the cover strip being extracted from its pocket to such an extent that supporting elements etc. are hidden.

In a preferred embodiment, the holder means are a plurality of leaf springs distributed along the sectional element.

The supporting surface and the leg of the cover strip are preferably substantially horizontal. Besides the substantially horizontal leg, the cover strip can also have a substantially vertical leg.

### BRIEF DESCRIPTION OF THE DRAWINGS

The invention will now be described in more detail with reference to the accompanying drawings.

FIG. 1 is a front view of a built-in balcony provided with a frame device according to the present invention.

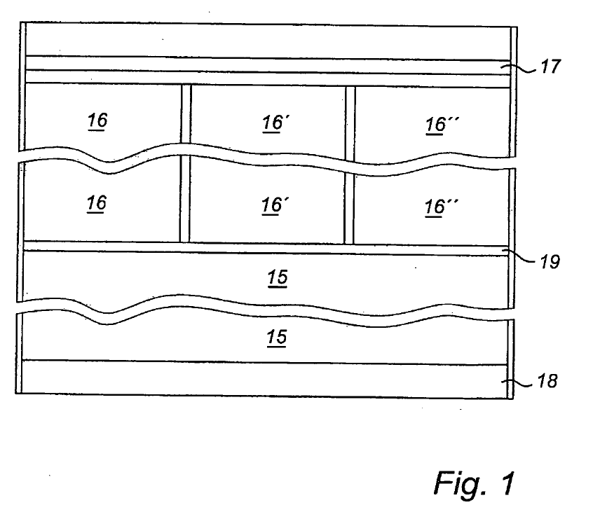

FIG. 2 shows the balcony from the right in FIG. 1, the frame side elements of the frame device being removed.

FIG. 3 shows a portion of FIG. 2 on a larger scale, a cover strip being shown in a retracted position.

FIG. 4 corresponds to FIG. 3 but shows the cover strip in an extracted position.

### DESCRIPTION OF A PREFERRED EMBODIMENT

The balcony shown in the drawings has a horizontal balcony slab 1 and a horizontal roof slab 2, which is located straight above the former and which in this case serves as a balcony slab for an upper balcony. Correspondingly, the balcony slab 1 can serve as a roof slab for a lower balcony. The two slabs 1 and 2 are concrete or steel slabs, which are fastened to a house wall (not shown) in a conventional manner.

A plurality of L-shaped holder elements 3, which have a horizontal leg 3a and a vertical leg 3b, are fastened, in a spaced-apart manner, by means of bolts 6, to the front edge surface 4 and the side edge surfaces 5 of the roof slab 2. The vertical leg 3b of the holder elements 3 abuts against the associated edge surface 4, 5, and their horizontal leg 3a projects therefrom at the lower end of the vertical leg 3b. The bolt 6 extends through an elongated hole 7 in each vertical leg 3b, which allows some adjustment of the vertical position of the horizontal leg 3a.

A plurality of L-shaped supporting elements 8, which have a horizontal leg 8a and a vertical leg 8b, are fastened, in a spaced-apart manner, by means of bolts 11, to the front edge surface 4 and 9, respectively, and the side edge surfaces 5 and 10, respectively, of the roof slab 2 and of the balcony slab 1. The vertical leg 8b of the supporting elements 8 abuts against the associated edge surface 4, 5, 9, 10, and their horizontal leg 8a projects therefrom at the upper end of the vertical leg 8b. The bolt 11 extends through an elongated hole 12 in each vertical leg 8b, which allows some adjustment of the vertical position of the horizontal leg 8a.

Each supporting element 8 has a ridged part 13, which is arranged on its horizontal leg 8a and extends parallel to the respective edge surfaces 4, 5, 9, 10. The ridged part 13 is fastened to the supporting element 8 by means of a bolted joint 14, which extends through an elongated hole (not shown) in the horizontal leg 8a, which allows some adjustment of the distance of the ridged part 13 from the respective edge surfaces 4, 5, 9, 10.

The balcony is built-in and has, on its front side, a fixed lower wall plate 15 made of sheet metal and three glass plates 16, 16′, 16″, which are horizontally movable relative to each other. The wall plate 15 and the glass plates 16, 16′, 16″ are mounted in a frame device according to the invention, which has an upper horizontal sectional element 17, a lower horizontal sectional element 18 and an intermediate horizontal sectional element 19. The wall plate 15 is mounted between the lower sectional element 18 and the intermediate sectional element 19. The glass plates 16, 16′, 16″ are mounted in a manner known per se between the upper sectional element 17 and the intermediate sectional element 19 and are movable relative to each other. The sectional elements 17, 18, 19 are suitably made of aluminium.

The drawings show a corresponding lower sectional element 18′ in a frame device at the upper balcony. The two lower sectional elements 18 and 18′ are identical.

The lower sectional element 18 (18′) has a longitudinal groove 20 (20′) on its underside and a vertically downwardly projecting outer flange 21 (21′) on its front side.

The lower sectional element 18 of the frame device rests on the lower supporting elements 8. The ridged part 13 of each supporting element 8 is positioned in the groove 20 of the lower sectional element 18. The lower sectional element 18 rests on the front edge surface 9 of the balcony slab 1 by way of a strip seal 23.

The frame device at the upper balcony is supported in corresponding manner by the upper supporting elements 8, the lower sectional element 18′ resting on the front edge surface 4 of the roof slab 2 by way of a strip seal 23′.

The upper sectional element 17 of the frame device abuts from the underside against the horizontal leg 3a of the holder elements 3 and is fastened thereto by means of a bolted joint 24, which extends through an elongated hole (not shown) in each leg 3a. This allows some adjustment of the distance of the upper sectional element 17 from the respective edge surfaces 4, 5 of the roof slab 2.

When a balcony is built-in, the supporting elements 8 and the holder elements 3 are first fastened to the balcony slab 1 and the roof slab 2 in the manner described above. After that, the frame device is positioned on the lower supporting elements 8 in such a manner that their ridged parts 13 are received in the groove 20 in the lower sectional element 18. Subsequently, the upper sectional element 17 is fastened to the holder elements 3 by means of the bolted joints 24. It is possible to compensate for any dimensional tolerances in the vertical and the lateral directions thanks to the fact that the position of the holder elements 3 and the supporting elements 8 can be adjusted in the vertical direction and that of the bolted joints 14 and 24 in the lateral direction.

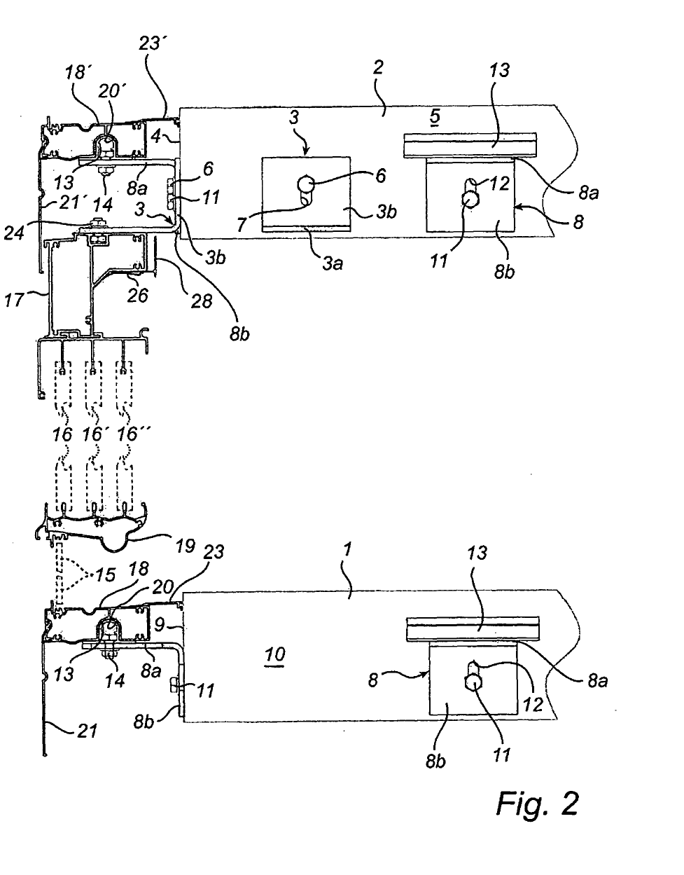

The upper horizontal sectional element 17 has a downwardly facing supporting surface 25, to which a plurality of leaf springs 26 are fastened at a distance from each other along the sectional element 17. The leaf springs 26 extend at right angles to the longitudinal direction of the sectional element 17 and are fastened to the supporting surface 25 at their outer end, for instance, by means of screws (not shown). Each leaf spring 26 forms together with the supporting surface 25 a pocket 27 which is open inwardly towards the balcony (to the right in FIGS. 2-4).

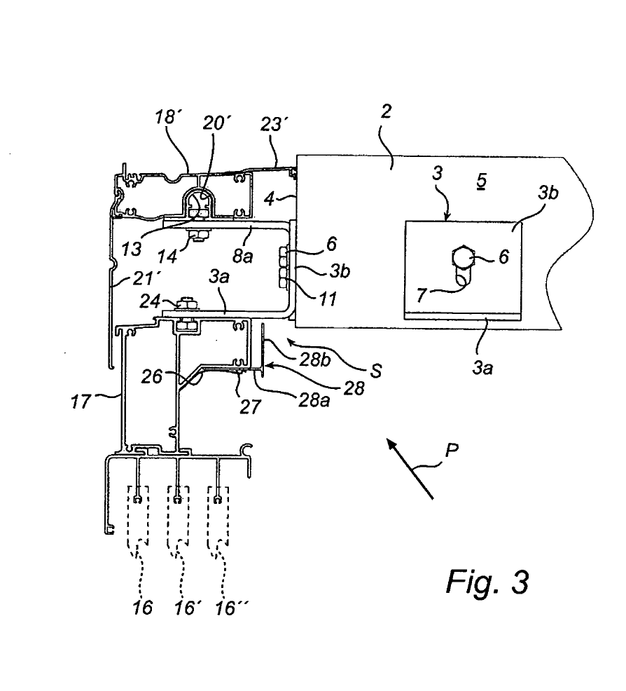

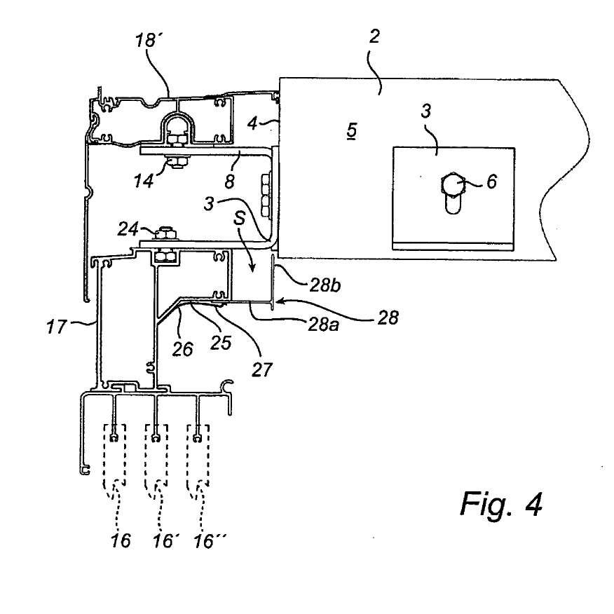

A cover strip 28, which is substantially L-shaped in cross-section and which extends parallel to the sectional element 17 and has a horizontal leg 28a and a vertical leg 28b, is inserted into the pocket 27 with its horizontal leg 28a. When storing, transporting and mounting the frame device, the cover strip 28 is in a maximally retracted position (FIGS. 2 and 3) in the pocket 27. From this position, the cover strip 28 is extractable to an arbitrarily extracted position (FIG. 4).

When the frame device is mounted on the balcony, which, as mentioned above, is performed with the cover strip 28 in a retracted position, a gap S forms between the roof slab 2 and the upper horizontal sectional element 17. Through this gap S, substantially in the direction of the arrow P, at least parts of the holder elements 3 and the supporting elements 8 fastened to the roof slab 2 and parts of the bolted joints 14 and 24 are visible from the balcony. By extracting the cover strip 28 to a suitable position (FIG. 4), after the mounting operation, it is possible to give the transition area between the roof slab 2 and the upper horizontal sectional element 17 of the frame device an aesthetically more pleasing appearance in a very simple and rapid manner.

1. A frame device, which is adapted to be mounted between a balcony slab (1) and a roof slab (2) located straight above the former and to support wall elements (15, 16, 16′, 16″), such as glass plates, for at least partial building-in of a balcony and which has an upper horizontal sectional element (17), which is adapted to be positioned, when mounting the frame device, close to the roof slab (2), wherein the sectional element (17) supports a cover strip (28) which is fastened thereto by holder means (26) and which extends parallel to the sectional element (17) and has a leg (28a), which is inserted into a pocket (27) formed between the holder means (26) and a supporting surface (25) of the sectional element (17), the cover strip (28) being extractable from a retracted position in the pocket (27) to an arbitrarily extracted position so as to provide, when the frame device is mounted between the balcony slab (1) and the roof slab (2), a visual screening off of a gap (S), which is formed between the roof slab (2) and the sectional element (17).

2. A frame device as claimed in claim 1, in which the holder means are a plurality of leaf springs (26) distributed along the sectional element (17).

3. A frame device as claimed in claim 1, in which the supporting surface (25) and said leg (28a) are substantially horizontal.

4. A frame device as claimed in claim 3, in which the cover strip (28) also has a substantially vertical leg (28b).

5. A frame device as claimed in claim 2, in which the supporting surface (25) and said leg (28a) are substantially horizontal.

6. A frame device as claimed in claim 5, in which the cover strip (28) also has a substantially vertical leg (28b).
